(19) United States
(12) Patent Application Publication
(10) Pub. No.: US 2017/0052683 A1
(43) Pub. Date: Feb. 23, 2017

(54) ALTERING A DISPLAY PERSPECTIVE TO AVOID SCROLLING

(71) Applicant: International Business Machines Corporation, Armonk, NY (US)

(72) Inventors: DONALD L. BRYSON, Chattanooga, TN (US); Sarbajit K. Rakshit, Kolkata (IN)

(73) Assignee: International Business Machines Corporation, Armonk, NY (US)

(21) Appl. No.: 14/831,237

(22) Filed: Aug. 20, 2015

(51) Int. Cl. G06F 3/0484; G06F 3/14; G06F 3/0481; G09G 5/373; G09G 5/38

(52) U.S. Cl. CPC G06F 3/04845; G09G 5/373; G09G 5/38; G06F 3/04815; G06F 3/1415; G09G 2340/0464; G09G 2340/145; G09G 2320/068; G09G 2370/02

(57) ABSTRACT

For altering a display perspective to avoid scrolling, a first dimension of a layout of a content is determined to exceed a first dimension of a display area by a first difference. A first angle of inclination is computed using the first dimension of the layout and the first dimension of the display area. An inclined layout is displayed by inclining the layout on an imaginary plane. A three-dimensional perspective of the imaginary plane is displayed at the first angle of inclination relative to a plane of the display area. The inclined layout displays the first dimension of the layout completely in the first dimension of the display area thereby avoiding using a scrolling function despite the first difference. The content of the layout remains capable of a manipulation in the inclined layout according to a permission for the manipulation in the layout from a source.

### TECHNICAL FIELD

The present invention relates generally to a method, system, and computer program product for displaying data. More particularly, the present invention relates to a method, system, and computer program product for altering a display perspective to avoid scrolling.

### BACKGROUND

Data processing systems of many types have associated therewith some mechanism to visually present, display, or render data. For example, a desktop computer has a computer monitor on which the computer displays data. As another example, a portable device such as a smartphone or a tablet computer includes a screen on which the portable device displays data. An embedded data processing system also connects to a visual presentation mechanism on which the embedded data processing system visually presents data to human users.

Within the scope of this disclosure, a display device is any type of data processing system that is coupled with a visual presentation device on which data can be visibly presented to a human user. Within the scope of this disclosure, displaying data, presenting data, or rendering data, interchangeably mean a suitable manner of outputting data on a display device such that the outputted data is visibly perceivable by the human user.

A data source provides data in a layout preferred by the data source. In many cases, the layout of the data on a display device is guided by a specification or code provided by the data source and interpreted by the display device. Within the scope of the disclosure, a layout is any suitable manner of specifying one or more dimensions of an area in which the data should be displayed in a display device.

For example, a data source may specify that the provided data should be displayed on a display device in a grid that is ten columns wide and fifty rows tall, where each cell in the grid has a certain size. As another example, a code of a webpage may inform a browser application on a display device that a feature of the webpage should be rendered in an area no less than twelve hundred pixels wide by twelve hundred pixels tall.

An area usable for displaying data on the display device, e.g., a usable screen area, can be smaller than the area specified in a layout. Under such circumstances, the display device displays a portion of the layout including a corresponding portion of the data therein, and displays one or more scrolling features to scroll to other portions of the layout for viewing other corresponding portions of the data therein.

For example, a horizontal scroll bar allows a user to scroll along X-axis, to wit, scroll left or scroll right, to bring different laterally arranged portions of a given vertical level of a layout into view on the display device. Similarly, a vertical scroll bar allows a user to scroll along Y-axis, to wit, scroll up or scroll down, to bring different vertically arranged portions of a given lateral level of a layout into view on the display device.

### SUMMARY

The illustrative embodiments provide a method, system, and computer program product for altering a display perspective to avoid scrolling. An embodiment includes a method for altering a display perspective to avoid scrolling. The embodiment determines, using a processor and a memory at a data processing system, that a first dimension of a layout of a content exceeds a first dimension of a display area by a first difference. The embodiment computes a first angle of inclination using the first dimension of the layout and the first dimension of the display area. The embodiment displays an inclined layout by inclining the layout on an imaginary plane, a three-dimensional perspective of the imaginary plane being at the first angle of inclination relative to a plane of the display area. The inclined layout displays the first dimension of the layout completely in the first dimension of the display area thereby avoiding using a scrolling function despite the first difference. The content of the layout remains capable of a manipulation in the inclined layout according to a permission for the manipulation in the layout from a source.

Another embodiment includes a computer readable article of manufacture embodying computer readable instructions which, when executed, cause a computer to carry out steps of the method for altering a display perspective to avoid scrolling.

Another embodiment includes a data processing system for altering a display perspective to avoid scrolling.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example layout display problem that can be remedied using an illustrative embodiment;

FIG. 4 depicts a block diagram of an example manner of altering a display perspective to avoid scrolling in accordance with an illustrative embodiment;

FIG. 5 depicts a block diagram of scaling in accordance with an illustrative embodiment;

FIG. 6 depicts a block diagram of another example manner of altering a display perspective to avoid scrolling in accordance with an illustrative embodiment;

FIG. 7 depicts a block diagram of another example manner of altering a display perspective to avoid scrolling in accordance with an illustrative embodiment; and

FIG. 8 depicts a flowchart of an example process for altering a display perspective to avoid scrolling in accordance with an illustrative embodiment.

### DETAILED DESCRIPTION

The illustrative embodiments recognize that scrolling to view different parts of a given layout can be difficult under many circumstances. For example, portable display devices such as smartphones and tablet computers often have significantly smaller display areas as compared to an area needed to fully display a layout. Scrolling on small display devices is problematic due to miniaturized scrolling controls, difficulty in controlling the granularity of the scrolling action due to the small display area, difficulty of a user in performing tactile operations or gesture-based operations to perform the scrolling, or some combination of these and other problems.

Scrolling on bigger monitors is also not without problems. For example, often, a user will have several applications displaying data in different areas of the monitor, which effectively reduces the monitor to a small display area as far as the display of a particular application is concerned, and the same problems as a portable device arise on large monitors as well. As another example, even if the monitor offers a large display area, the scrolling requires manipulating a pointing device, such as a mouse or a track ball, which can be difficult for some users with disabilities. Regardless of device-specific problems related to scrolling, scrolling generally is not a desirable operation because scrolling forces a user to perceive the layout one piece at a time instead of in a big-picture way.

The illustrative embodiments used to describe the invention generally address and solve the above-described problems and other problems related to the need to scroll a layout when the layout is presented on a comparatively small display area of a display device. The illustrative embodiments provide a method, system, and computer program product for altering a display perspective to avoid scrolling.

One or more embodiments described herein can be implemented as an application executing using a processor and a memory in a display device.

An embodiment compares a dimension of a layout with a dimension of a display area available to display the layout on a display device. A dimension is a measurement of a side. For example, a dimension of a layout can be a height or a width of the layout. Similarly, a dimension of the display area available for displaying the layout on a display device can be height of the display area or a width of the display area.

Assume, as a simplified example that a given layout is wider than the display area on which the layout has to be displayed. According to the prior-art, a horizontal scroll bar is going to be needed for piecemeal viewing of the entire width of the layout in the display area.

An embodiment computes an angle of inclination. An angle of inclination according to the illustrative embodiments is an internal angle between a hypotenuse and a base of a right triangle, where the dimension of the layout forms the hypotenuse and a corresponding dimension of the display area forms the base of the right triangle.

An embodiment presents the layout on a plane in the display area, where the plane appears to be inclined relative to the plane of the display area at the angle of inclination. Note that the plane is not a physical plane, but a graphically depiction of the layout such that the layout graphically appears to be positioned at the angle of inclination relative to the plane of the display area. The angle of inclination of the plane visually makes a two-dimensional presentation of the plane appear to be inclined in three-dimensions by adjusting the features of the plane to give a perception of depth in the two-dimensional display area of the display device.

When an embodiment presents the wider layout on the inclined plane in the manner described above, the entire width of the example layout fits on the hypotenuse of the right triangle, and is therefore perceptible on the base-sized width of the display area. A horizontal scroll bar is therefore no longer required to view the entire width of the example layout. The inclined plane appears as if one side, e.g., the left side, of the layout is closer to the user as compared to the opposite side, e.g., the right side. In other words, the layout, which is presented on an X-axis-Y-axis plane of the display area, appears to have been rotated along the Y axis by the angle of inclination.

As another example, suppose that the layout were taller than the height of the available display area. According to an embodiment, the height of the layout forms the hypotenuse and the height of the display area forms the base of a right triangle. When an embodiment presents the taller layout on the inclined plane in the manner described above, the entire height of the example layout fits on the hypotenuse of the right triangle, and is therefore perceptible on the base-sized height of the display area. A vertical scroll bar is therefore no longer required to view the entire height of the example layout. The inclined plane appears as if one side, e.g., the bottom edge, of the layout is closer to the user as compared to the opposite side, e.g., the top edge. In other words, the layout, which is presented on an X-axis-Y-axis plane of the display area, appears to have been rotated along the X axis by the angle of inclination.

As another example, suppose that the layout were both wider and taller than the width and the height of the available display area. An embodiment computes two angles of inclinations—one where the entire width of the example layout fits on the hypotenuse of a first right triangle, and is therefore perceptible on the base-sized width of the display area, and the other where the entire height of the example layout fits on the hypotenuse of another right triangle, and is therefore perceptible on the base-sized height of the display area. The inclined plane appears as if one corner, e.g., the left bottom corner, of the layout is closer to the user as compared to the other three corners, e.g., the right bottom corner, the top left corner, and the top right corner. In other words, the layout, which is presented on an X-axis-Y-axis plane of the display area, appears to have been rotated along both the X axis and the Y axis, for example, pivoted at the closest corner.

Normally, when content is viewed at an oblique angle, as would be the case when the content of the layout is presented on the inclined plane, the content that occupies the nearest end of the layout appears the largest and the most readable or distinguishable with the best available clarity; the content from the nearest end to the farthest end of the inclined plane progressively becomes smaller and less clear; and the content that occupies the farthest end appears the smallest and often unreadable or indistinguishable with least available clarity.

A portion of a layout can include textual content, image content, graphical content, or some combination thereof. A flat-dimension of a portion of layout content is a dimension of that portion on the display device when the layout is displayed on the display area at no inclination relative to the plane of the display area. A flat-dimension can be a flat-height, a flat-width, a flat-perceived depth, a flat-radius, a flat-font size, or another suitable flat measurement.

A distance-dimension of a portion of layout content is a dimension of that portion on the display device when the layout is displayed on the display area on an inclined plane as described herein. A distance—dimension can be a distance—height, a distance—width, a distance—perceived depth, a distance—radius, or another suitable distance measurement. The farther the distance of a portion of a layout content is on an inclined plane from the nearest end of the inclined plane, the smaller the distance dimension of the portion is as compared to the flat-dimension of the portion.

An embodiment further improves the readability of the layout that is to be presented on the inclined plane. The embodiment computes a scaling factor. The scaling factor is a ratio by which a distance-dimension of a portion of a layout content has to be increased—or scaled up—such that the distance-dimension of the portion visually appears to be the flat-dimension of the portion when the portion is positioned and displayed as a part of the layout on the inclined plane. Note that different scaling factors may be applied to different distances from the nearest end, different scaling factors may be applied to different portions, different scaling factors may be applied to different types of portions, or a combination thereof.

For example, consider that a portion includes text in font size 8. Thus, the flat-dimension of the portion is font size 8. When the portion is at the nearest end of the layout, the distance of the portion from the nearest end is zero, and the distance-dimension of the portion remains the same as the flat-dimension, to wit, font size 8. When the portion is half-way between the nearest end of the layout and the farthest end of the layout on the inclined plane, without a scaling up, font size 8 appears like font size 6; and when the portion is at the farthest end of the layout, the distance of the portion from the nearest end is at a maximum, and the distance-dimension of the portion appears like font size 4.

An embodiment applies one or more scaling factors to the text in the above example. For example, the embodiment scales up the portion that is half-way between the nearest end of the layout and the farthest end of the layout on the inclined plane to a distance-dimension of font size 10, which appears like the flat-dimension of font size 8 on the inclined plane. The embodiment scales up the portion that is at the farthest end of the layout to a distance-dimension of font size 12, which appears like the flat-dimension of font size 8 on the inclined plane. The embodiment scales up various intermediate portions at various intermediate distances according to a scaling factor that is proportional to their distance on the inclined plane from the nearest end of the inclined plane in a similar manner.

Changing an orientation of a document normally prevents the editing or manipulating of that document in the presently available tools. An embodiment maintains the editability of the content of the layout when the layout is displayed on the inclined plane as described herein. Other manipulations of the content, including but not limited to editing of the content, which are possible in a flat-view remain available in an inclined view of the content. For example, when a portion of the layout is located on an inclined plane as described herein, the portion can be edited while the layout remains displayed on the inclined plane. Furthermore, an embodiment allows such editing or manipulating with or without scaling the portion, as described herein.

A method of an embodiment described herein, when implemented to execute on a device or data processing system, comprises substantial advancement of the functionality of that device or data processing system in viewing data on a display device without scrolling the data. For example, prior-art requires that a layout that is larger than the available area to display the layout on a display device must be scrolled to bring the various off-display portions of the layout into view. An embodiment enables a user to be able to view the larger layout on the available display area without using or needing one or more scrolling functions. Furthermore, an embodiment maintains the readability of the contents of the layout when presenting such a view of the layout. An embodiment also keeps the contents of the layout available for editing or other manipulations while the layout remains presented in this manner. Operating in a manner described herein, an embodiment performs altering a display perspective to avoid scrolling. Such manner of displaying data is unavailable in presently available devices or data processing systems. Thus, a substantial advancement of such devices or data processing systems by executing a method of an embodiment is valuable in reducing the effort in viewing a layout of data, and improves a user's experience in interacting with the data.

The illustrative embodiments are described with respect to certain data, content, layout, portions, planes, axes, angles, dimensions, ratios, factors, manipulations, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

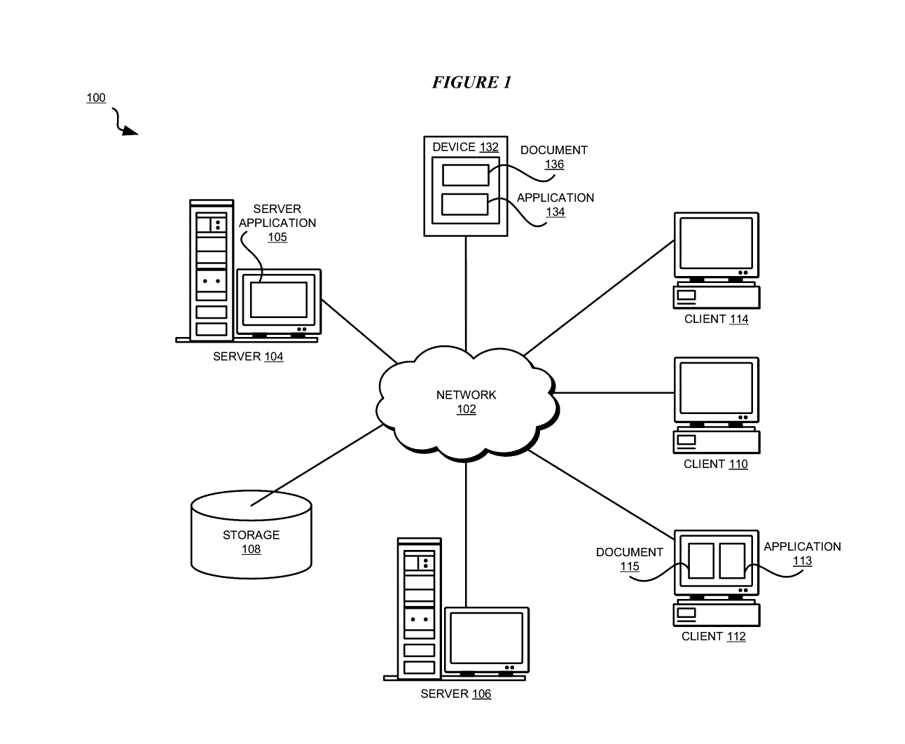

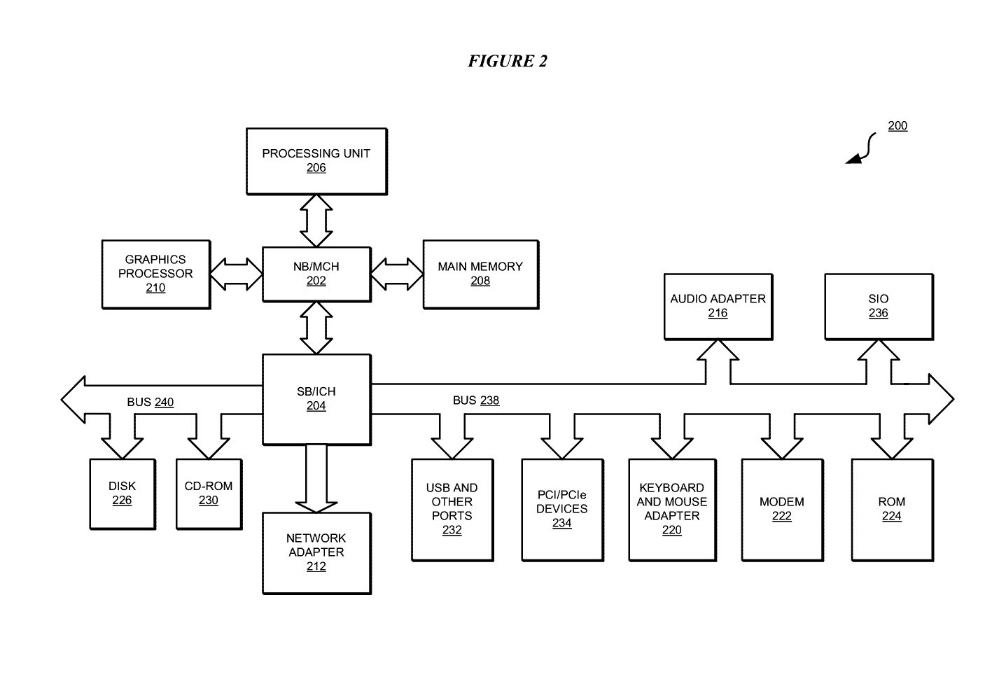

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Device 132 forms a display device as described herein by including, or having coupled therewith, a screen on which to display content. Client 112 is another example of a display device, by having coupled therewith a monitor on which content can be displayed to a user. Applications 113 and 134 each implements an embodiment described herein. As a non-limiting example, document 115 is an example of content arranged in a layout. Document 134 similarly is another example of content arranged in a layout. Documents 115 and 134 may be supplied by any suitable data source, such as in the form of a webpage from server application 105. Documents 115 and 134 may each include any type of content, and may arrange such content in any type of layout, for presentation on display devices such as device 132 and client 112, respectively, in an inclined manner as described herein.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 and 142 in FIG. 1 in which computer usable program code or instructions implementing the processes of the illustrative embodiments may be located. Data processing system 200 is described as a computer only as an example, without being limited thereto. Implementations in the form of other devices, such as device 132 and 142 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as client applications 113 and 134 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

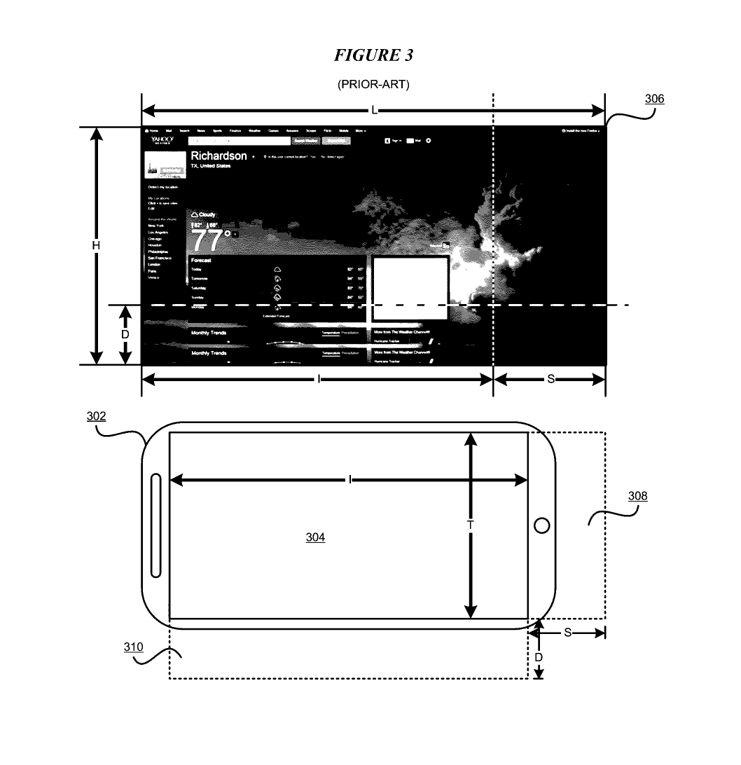

With reference to FIG. 3, this figure depicts a block diagram of an example layout display problem that can be remedied using an illustrative embodiment. Device 302 is an example of device 132 in FIG. 1, but client 112 in FIG. 1 can be used in place of device 302 as well. Layout 306 is an example of document 115 or 134 in FIG. 1.

Client 302 includes display area 304 in which layout 306 has to be displayed. Display area 304 has a height dimension T and a width dimension I as shown. In other words, layout 306 can be displayed in display area of I*T units.

Layout 306 has a width dimension L, and a height dimension H. L exceeds I by S units, H exceeds T by D units, or both. Therefore, portion 308, 310, or both, cannot be accommodated in display area 304. Accordingly, portion 308 requires horizontal scrolling function to be present in display area 304, portion 310 requires vertical scrolling function to be present in display area 304, or both, as the case may be.

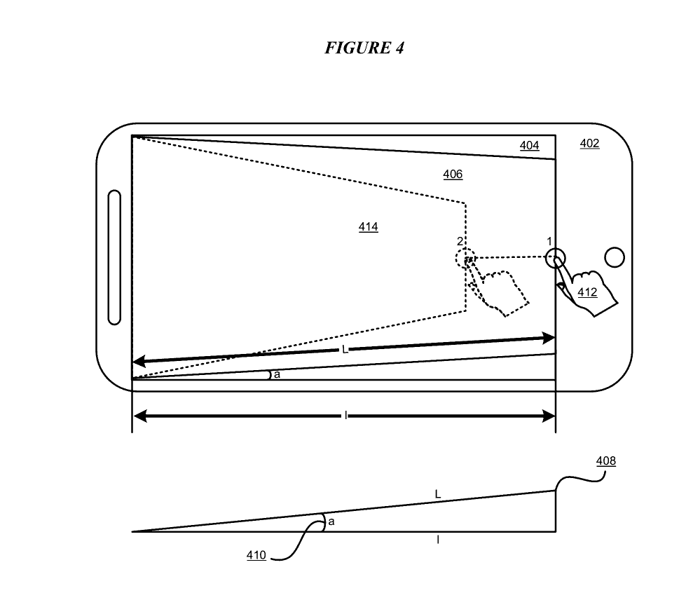

With reference to FIG. 4, this figure depicts a block diagram of an example manner of altering a display perspective to avoid scrolling in accordance with an illustrative embodiment. Display device 402 including display area 404 is an example of display device 302, which includes display area 304 in FIG. 3.

An application, such as application 134 in FIG. 1, causes layout 306 in FIG. 3 to be presented on an inclined plane in display area 404, in the example manner of layout 406. An angle of inclination “a” is the angle by which a plane of layout 406 appears inclined with respect to a plane of display area 404.

Right triangle 408 depicts the relationship between a dimension of layout 406 and a dimension of display area 404. For this example, ignore any discrepancies between the height dimension of layout 406 and the height dimension of display area 404. Right triangle 408 shows that internal angle 410 between width dimension L of layout 406 and width dimension I of display area 404 is “a”.

An embodiment further allows a user to control the angle of inclination. For example, using an example touch-based gesture—gesture 412—the user can change the angle of inclination “a”. Only as a non-limiting example, when gesture 412 is at position 1, the angle of inclination is angle “a”. When gesture 412 is at position 2, the angle of inclination is greater than angle “a” and layout 406 appears as layout 414.

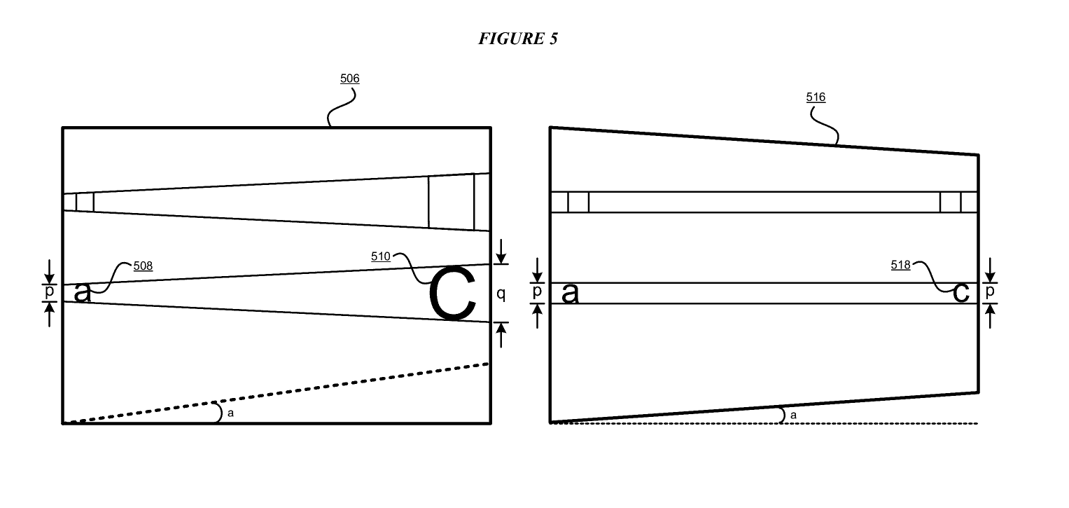

With reference to FIG. 5, this figure depicts a block diagram of scaling in accordance with an illustrative embodiment. Layout 506 is an example of layout 306 in FIG. 3.

As a non-limiting example, consider portion 508, which includes text of dimension “p”. Dimension P is a flat-dimension of portion 508 and can be designated as a font size, pixel size, units of measurement, or in any other suitable manner.

An embodiment, such as in application 134 or 113 in FIG. 1, computes an angle of inclination “a” as described herein and as depicted in FIG. 4. Based on “a”, the application computes a scaling factor “f”.

Portion 510 is another portion of layout 506. According to the computed angle “a”, the application determines that portion 510 will appear farther than portion 508 when layout 506 is presented on an inclined plane in the manner of layout 516. Layout 516 is an example of layout 406 in FIG. 4.

Assume that portions 508 and 510 have the same flat dimension p. The application scales up portion 510 to distance-dimension “q”. The application computes distance-dimension q according to scaling factor f. In one embodiment, scaling factor f depends only on angle a. In another embodiment, scaling factor f depends on distance “x”, which is the distance of portion 510 on layout 516 from the end of layout 516 that appears to be closest to the user. In another embodiment, scaling factor f is computed using angle a and distance x.

The application displays layout 506 as inclined layout 516. On inclined layout 516, scaled portion 510 of layout 506 appears as portion 518. A dimension of portion 518 appears to be the same as flat-dimension p in layout 506. One embodiment causes portion 518 to appear larger than flat-dimension p (not shown) for improved readability.

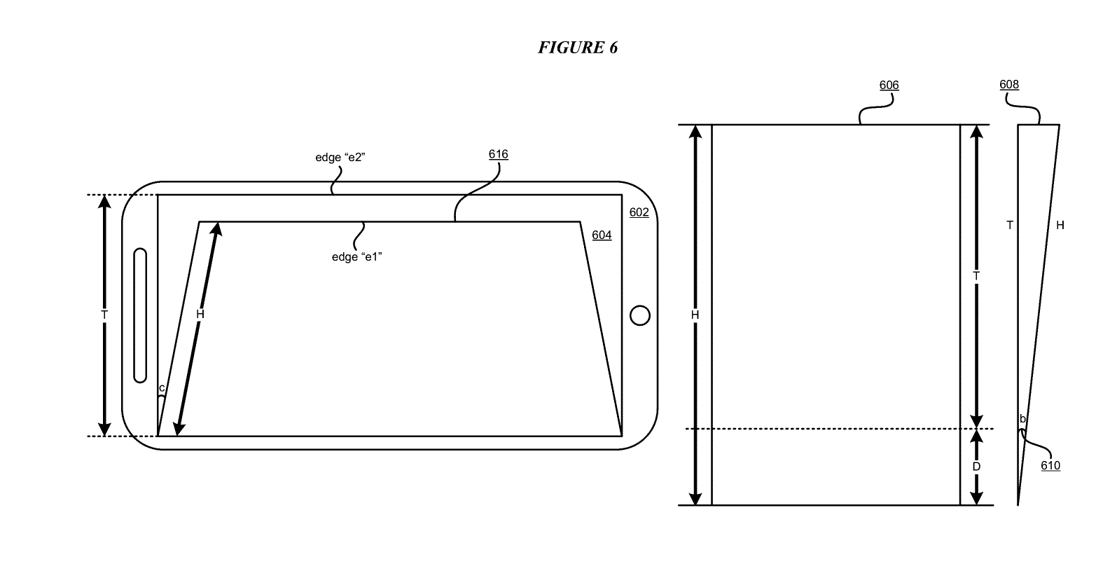

With reference to FIG. 6, this figure depicts a block diagram of another example manner of altering a display perspective to avoid scrolling in accordance with an illustrative embodiment. Display device 602 including display area 604 is an example of display device 402, which includes display area 404 in FIG. 4.

Right triangle 608 depicts the relationship between a dimension of layout 606 and a dimension of display area 604. For this example, ignore any discrepancies between the width dimension of layout 606 and the width dimension of display area 604. Right triangle 608 shows that internal angle 610 between height dimension H of layout 606 and height dimension T of display area 604 is “b”.

An application, such as application 134 in FIG. 1, causes layout 606 to be presented on an inclined plane in display area 604, in the example manner of layout 616. An angle of inclination “c” is the angle by which a plane of layout 616 appears inclined with respect to a plane of display area 604.

Assume that a user input, such as in the manner of gesture 412 at position 2 in FIG. 4 has increased the angle of inclination of inclined layout 616. The actual angle at which inclined layout 616 appears inclined to the user is angle “c”, which is greater than angle “b” in the depiction. If the angle of inclination of inclined layout 616 were “b”, edge “e1” of inclined layout 616 would be the same as edge “e2” of display area 604, or at least be closer to edge e2 than shown as a result of angle “c”.

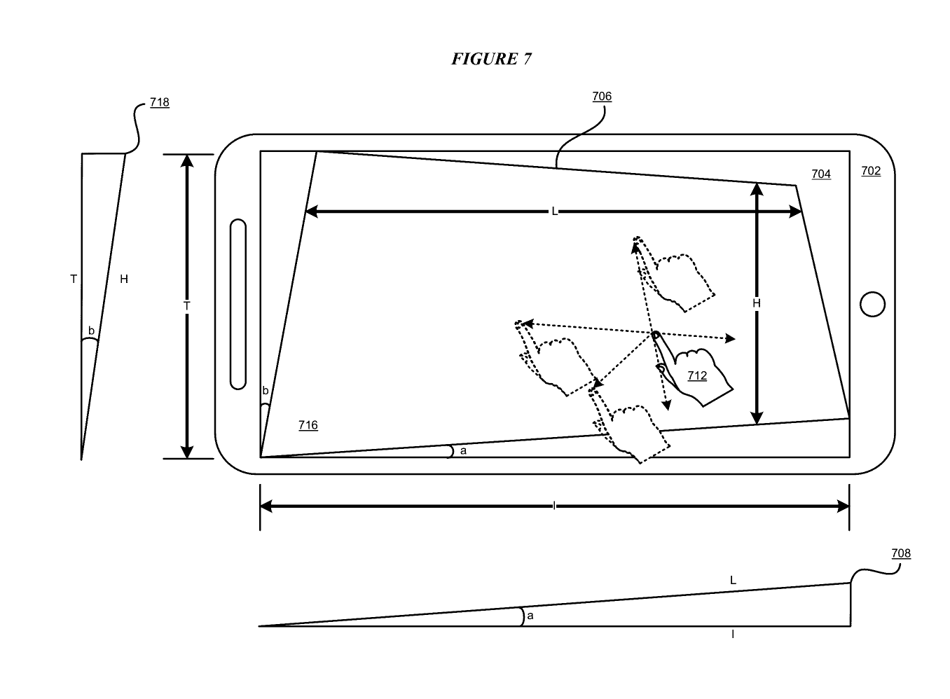

With reference to FIG. 7, this figure depicts a block diagram of another example manner of altering a display perspective to avoid scrolling in accordance with an illustrative embodiment. Display device 702 including display area 704 is an example of display device 602, which includes display area 604 in FIG. 6. Layout 306 in FIG. 3 is an example original layout that is inclined as layout 706 in accordance with an embodiment.

Right triangle 708 depicts angle of inclination “a” between width dimension L of layout 306 and width dimension I of display area 704. This angle causes layout 306 to be rotated along Y-axis as shown. Right triangle 718 depicts angle of inclination “b” between height dimension H of layout 306 and height dimension T of display area 704. This angle causes layout 306 to be rotated along X-axis as shown. Thus, angles a and b cause original layout 306 to be rotated along both X-axis and Y-axis in the manner depicted.

Inclined in this manner, the lower left corner of inclined layout 706 appears closest to the user, and the upper right corner of layout 706 appears the farthest from the user. According to one embodiment, one or more scaling factors can be applied to portions of layout 306 for improving the readability of such portions when presented as a part of layout 706. According to another embodiment, in inclined layout 706, such portions remain editable or capable of manipulations just as they were in original layout 306.

An embodiment further allows a user to control the angle of inclination as described with respect to FIG. 4. For example, using an example touch-based gesture—gesture 712—the user can change angle of inclination “a”, angle of inclination “b”, or both. For example, gesture 712 can be moved to, or made at any of the several example positions shown to change the rotation of layout 706 about the X-axis, the Y-axis, or both.

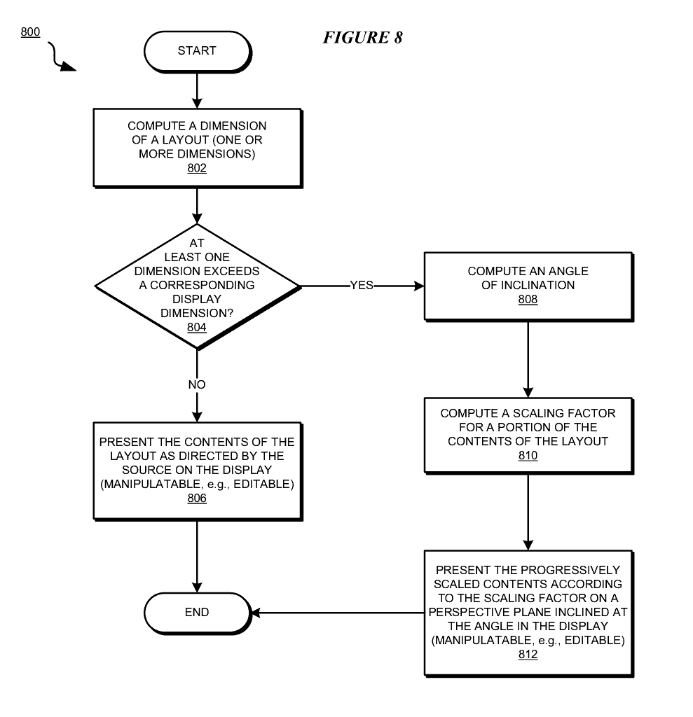

With reference to FIG. 8, this figure depicts a flowchart of an example process for altering a display perspective to avoid scrolling in accordance with an illustrative embodiment. Process 800 can be implemented in application 113 or 134 in FIG. 1. Only as a non-limiting example, process 800 is depicted and described for inclining a layout only in one direction, to wit, about one axis to accommodate a difference in one dimension. From this disclosure, those of ordinary skill in the art will be able to adapt process 800 for inclining a layout in multiple directions, to wit, about multiple axes to accommodate differences in more than one dimension, and the same is contemplated within the scope of the illustrative embodiments.

The application computes a dimension of a layout (block 802). The application determines whether at least one dimension exceeds a corresponding dimension of a display area on a display device (block 804).

If no dimension exceeds the corresponding dimension of the display area (“No” path of block 804), the application presents or displays the contents of the layout as directed by the source or the code of the layout (block 806). The application ends process 800 thereafter. The contents of the inclined layout can be manipulated, e.g., edited, as may be permitted by the source or the code of the layout.

If at least one dimension exceeds the corresponding dimension of the display area (“Yes” path of block 804), the application computes an angle of inclination (block 808). As described in this disclosure, this computed angle of inclination is a minimum angle of inclination to accommodate the discrepancy between the dimension of the layout and the corresponding dimension of the display area without needing a scrolling function along that dimension. A user can adjust (not shown) the computed angle, or input (not shown) a larger angle of inclination, as described elsewhere in this disclosure.

The application computes a scaling factor for a portion of the contents of the layout (block 810). The application presents or displays the contents of the layout in a progressively scaled manner according to one or more scaling factors on a perspective plane that is inclined at least at the computed angle of inclination (block 812). The application ends process 800 thereafter. The contents of the inclined layout can be manipulated, e.g., edited, in the inclined and scaled position, as may be permitted by the source or the code of the layout.

Thus, a computer implemented method, system or apparatus, and computer program product are provided in the illustrative embodiments for altering a display perspective to avoid scrolling. Where an embodiment or a portion thereof is described with respect to a type of device, the computer implemented method, system or apparatus, the computer program product, or a portion thereof, are adapted or configured for use with a suitable and comparable manifestation of that type of device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1-12. (canceled)

13. A computer readable article of manufacture embodying computer readable instructions which, when executed, cause a computer to carry out steps of a method for altering a display perspective to avoid scrolling, the method comprising:
determining, using a processor and a memory at a data processing system, that a first dimension of a layout of a content exceeds a first dimension of a display area by a first difference;
computing a first angle of inclination using the first dimension of the layout and the first dimension of the display area; and
displaying an inclined layout by inclining the layout on an imaginary plane, a three-dimensional perspective of the imaginary plane being at the first angle of inclination relative to a plane of the display area, wherein the inclined layout displays the first dimension of the layout completely in the first dimension of the display area, thereby avoiding use of a scrolling function despite the first difference, and wherein the content of the layout remains capable of a manipulation in the inclined layout according to a permission for the manipulation in the layout from a source.

14. The computer readable article of manufacture of claim 13 embodying instructions which, when executed, cause the computer to carry out the method further comprising:
determining a first dimension of a portion of the content, wherein the first dimension of the portion of the content is usable to display the portion in the layout without inclining the layout on the imaginary plane;
determining, using the angle of inclination, a second dimension of the portion of the content, wherein the second dimension of the portion of the content is usable to display the portion in the inclined layout; and
changing a size of the portion of the content from the first dimension to the second dimension in the layout, the changing causing the portion of the content to appear of the first dimension in the inclined layout.

15. The computer readable article of manufacture of claim 14 embodying instructions which, when executed, cause the computer to carry out the method further comprising:
determining a distance of the portion from a near-end of the inclined layout, wherein the near-end appears closest to a user in the three-dimensional perspective of the imaginary plane; and
further using, in determining the second dimension of the portion of the content, the distance of the portion from the near-end of the inclined layout.

16. The computer readable article of manufacture of claim 13 embodying instructions which, when executed, cause the computer to carry out the method further comprising:
determining a first dimension of a portion of the content, wherein the first dimension of the portion of the content is usable to display the portion in the layout without inclining the layout on the imaginary plane;
determining a distance of the portion from a near-end of the inclined layout, wherein the near-end appears closest to a user in the three-dimensional perspective of the imaginary plane; and
determining, using the distance of the portion from the near-end of the inclined layout, a second dimension of the portion of the content, wherein the second dimension of the portion of the content is usable to display the portion in the inclined layout; and
changing a size of the portion of the content from the first dimension to the second dimension in the layout, the changing causing the portion of the content to appear of the first dimension in the inclined layout.

17. The computer readable article of manufacture of claim 13 embodying instructions which, when executed, cause the computer to carry out the method further comprising:
determining that a second dimension of the layout of the content exceeds a second dimension of the display area by a second difference;
computing a second angle of inclination using the second dimension of the layout and the second dimension of the display area; and
further inclining the layout on the imaginary plane at the second angle of inclination relative to a plane of the display area, wherein the further inclining causes the second dimension of the layout to also be completely displayed in the second dimension of the display area and avoids using a second scrolling function despite the second difference.

18. The computer readable article of manufacture of claim 13 further embodying transferring instructions which, when executed, cause the computer to carry out the method further comprising:
transferring over a network from a remote data processing system, the computer readable instructions; and
storing, responsive to the transferring, the computer readable instructions in a data processing system.

19. The computer readable article of manufacture of claim 13 further embodying downloading instructions which, when executed, cause the computer to carry out the method further comprising:
downloading, from a server data processing system where the computer usable instructions are stored, over a network to a remote data processing system, the computer readable instructions for use in a computer readable storage device associated with the remote data processing system.

20. A data processing system for altering a display perspective to avoid scrolling, the data processing system comprising:
a storage device including a storage medium, wherein the storage device stores computer usable program code; and
a processor, wherein the processor executes the computer usable program code, and wherein the computer usable program code when executed causes the data processing system to carry out steps of a method, the method comprising:
determining, using a processor and a memory at a data processing system, that a first dimension of a layout of a content exceeds a first dimension of a display area by a first difference;
computing a first angle of inclination using the first dimension of the layout and the first dimension of the display area; and
displaying an inclined layout by inclining the layout on an imaginary plane, a three-dimensional perspective of the imaginary plane being at the first angle of inclination relative to a plane of the display area, wherein the inclined layout displays the first dimension of the layout completely in the first dimension of the display area, thereby avoiding use of a scrolling function despite the first difference, and wherein the content of the layout remains capable of a manipulation in the inclined layout according to a permission for the manipulation in the layout from a source.
